(19) United States
(12) Patent Application Publication
(10) Pub. No.: US 2025/0260426 A1
(43) Pub. Date: Aug. 14, 2025

(54) METHOD AND APPARATUS FOR REDUCING INTERFERENCE IN WIRELESS COMMUNICATION SYSTEMS

(71) Applicant: Analog Devices International Unlimited Company, Limerick (IE)

(72) Inventors: Patrick Pratt, Mallow (IE); Philip Eugene Quinlan, Glounthaune (IE)

(21) Appl. No.: 18/909,720

(22) Filed: Oct. 8, 2024

Related U.S. Application Data
(60) Provisional application No. 63/556,678, filed on Feb. 22, 2024.
(60) Provisional application No. 63/551,216, filed on Feb. 8, 2024.

(51) Int. Cl. H04B 1/10

(52) U.S. Cl. CPC H04B 1/1027

(57) ABSTRACT

There are provided methods and apparatuses for reducing the effect of interference at a receiver of a wireless communications system. They include receiving a transmitted bit stream at the receiver, determining a type of interference present in the transmitted bit stream, the type of interference comprising a first type of interference and a second type of interference, detecting the transmitted bit stream based on the type of interference present in the transmitted bit stream.

### CLAIM OF PRIORITY

This application is a U.S. Non-Provisional Application which claims priority to U.S. Provisional Application No. 63/551,216, filed Feb. 8, 2024, and 63/556,678, filed Feb. 22, 2024, both of which are hereby incorporated by reference herein in their entireties.

### FIELD

This application relates generally to methods and apparatuses for reducing the effect of interference and, in particular but not exclusively, to methods and apparatus for reducing the effect of interference at a receiver of a wireless communications system using multiple detectors.

### BACKGROUND

Wireless communications systems are susceptible to interferers, for example, blockers and jammers, from malicious or otherwise sources. The signals transmitted in these wireless communications systems may be susceptible to signals from interferers, which degrade the receiver sensitivity and consequentially the bit error rate (BER) causing packets to be dropped and ultimately packets to be retransmitted at the expense of throughput.

In traditional wireless communications systems, interference mitigation may conventionally be achieved by one or more of the following techniques to detect and correct errors, filter out unwanted signals, and adjust transmission power: coding, spreading, power adaptation and spatial cancellation. In coding, for example, error correction codes, redundancy in the form of coding is added to the transmitted message that improves immunity but at the expense of slower data throughput. In spreading, for example, Direct Sequence Spread Spectrum (DSSS) Frequency Hopping Spread Spectrum (FHSS) and Orthogonal Frequency Division Multiplexing (OFDM), data is spread over time or frequency, usually to increase the bandwidth. In power adaptation, for example, using power control, transmitter power is adapted dynamically depending on power level of interferer. In spatial interference cancellation, for example, adaptive filtering, spatial diversity is added by inclusion of more antennae.

However, the conventional techniques described above each add complexity to the transmitter and/or the receiver and have a high cost impact on the wireless communications system.

Therefore, it is desirable to provide an improved solution for reducing interference at a receiver of a wireless communications system.

### SUMMARY OF THE DISCLOSURE

The systems and methods of the present disclosure provide ways in which to reduce the effect of interference at a receiver of a wireless communications system using multiple detectors. The present disclosure is not only effective at reducing the effect of interference at the receiver by determining a type of interference present in the received signal, but it also removes complexity of the solution by correcting the signal at the receiver side without changing the transmitter channel/payload or adding unnecessary redundancy.

In one aspect of the present disclosure, there is provided a method of reducing the effect of interference at a receiver of a wireless communications system, the method comprising: receiving a transmitted bit stream at the receiver; determining a type of interference present in the transmitted bit stream, the type of interference comprising a first type of interference and a second type of interference; and detecting the transmitted bit stream based on the type of interference present in the transmitted bit stream.

By determining a type of interference present in the transmitted bit stream, a different detecting method may be used depending on the type of interference present in the transmitted bit stream. The detecting method may also be called a detection technique, and it can advantageously be suited to the particular type of interference that is present in the transmitted bit stream; recognising the type of interference allows switching between at least two different detection techniques and selecting the detection technique that works best with the type of interference that is determined.

The first type of interference may comprise at least one of wideband interference and narrowband off-channel interference. The method may further comprise using a first detection technique for the first type of interference. The first detection technique may comprise a Viterbi algorithm.

A Viterbi algorithm, used in a Viterbi detector, makes bit decisions by observing the received signal over several symbols in time (for example, by observing over a 2-5 symbol time-window, with increasing but diminishing process gain as the number of observation symbols increases and 5 symbols is approached. In practice, the complexity of the receiver, for example, in the Viterbi detector and/or the lookup table (LUT) etc, may increase as the number of observation symbols increases beyond 3. Therefore, it may be optimal to observe over a 3 symbol time-window.

The second type of interference may comprise narrowband in-channel interference. The method may further comprise using a second detection technique for the second type of interference. The second detection technique comprises a threshold detector algorithm.

A threshold detector algorithm, used in a threshold detector, may comprise a 1-bit algorithm utilizing a detection process that makes a decision on the received bit (logic 1 or 0) by observing the received signal over a 1 symbol period). The threshold detector may therefore perform threshold detection over a 1-symbol time-window. Note that “1-bit” does not refer the precision/resolution/number of bits employed in the digital hardware for symbol detection.

The method may further comprise dynamically switching between the first detection technique and the second detection technique depending upon the type of interference present in the transmitted bit stream. In other words, it is possible to dynamically switch between a Viterbi detector and a threshold detector depending on the interferer type that is determined. This can help performance of the method of the present disclosure since the Viterbi detector and the threshold detector can each perform better in response to certain types of interference.

In some examples, the type of interference may be determined by monitoring a signal spectrum using a Fast Fourier Transform (FFT) technique.

In the case of FFT, converting the received signal from the time domain to the frequency domain allows for analysis of frequency components of the signal. This enables real-time detection of different types of interference based on their frequencies.

Other ways in which the type of interference present in the transmitted bit stream may be determined include: Discrete Fourier Transform, DFT, a Goertzel Algorithm or Spectral filtering/classification on the transmitted bit stream, or wherein the interference determination unit is configured to use of Artificial Intelligence, AI, or Machine Learning, ML, algorithms to determine the type of interference present in the transmitted bit stream.

In some examples, the type of interference may be determined by using a received signal strength detector.

The method according to any preceding claim, wherein the transmitted bit stream is encoded and/or modulated, and the method further comprises decoding and/or demodulating the transmitted bit stream.

The transmitted bitstream may be (a) uncoded (no coding is applied) or (b) it may be encoded with some form of Forward Error Correction (FEC) coding such as Turbo Coding, Convolutional Coding etc.

The method may further comprises also applying Turbo Coding to the transmitter bit stream at the transmitter side.

The transmitted bitstream may typically then be modulated on to a transmit carrier using a phase/frequency/amplitude modulation technique at the transmitter side.

The method may further comprise demodulating the transmitted bit stream by calculating a phase and a magnitude of the transmitted bit stream.

The method may further comprise decoding the transmitted bit stream, for example, by identifying and correcting errors, and converting the encoded data back into its original format.

The method may further comprise outputting a detected bit stream from the receiver.

In another aspect of the present disclosure, there is provided an apparatus for reducing the effect of interference at a receiver of a wireless communications system, the apparatus comprising a detector configured to: receive a transmitted bit stream; determine a type of interference present in the transmitted bit stream, the type of interference comprising a first type of interference and a second type of interference; and detect the transmitted bit stream based on the type of interference present in the transmitted bit stream.

The detector may comprise an interference determination unit. The interference determination unit may be a Cognitive Interference Detection (CID) subsystem of the receiver.

The interference determination unit may be used to determine the type of interference present and hence selects a different detection technique depending on the type of interference that is detected.

The interference determination unit may be configured to perform spectral analysis, preferably a Fast Fourier Transform, FFT, a Discrete Fourier Transform, DFT, a Goertzel Algorithm or Spectral filtering/classification on the transmitted bit stream, or wherein the interference determination unit is configured to use of Artificial Intelligence, AI, or Machine Learning, ML, algorithms to determine the type of interference present in the transmitted bit stream.

The first type of interference may comprise at least one of wideband interference and narrowband off-channel interference.

The second type of interference may comprise narrowband in-channel interference.

Once the type of interference present in the transmitted bit stream has been determined, then a suitable detector may be selected to detecting the transmitted bit stream.

In the case where the first type of interference is determined, the detector may comprise a Viterbi detector for detecting the transmitted bit stream comprising the first type of interference. That is, a Viterbi detector may be used when the interference is narrowband and off the center of the channel or when it is broadband. For this first type of interference, a Viterbi detector may produce more accurate results than a threshold detector.

In the case where the second type of interference is determined, the detector may comprise a threshold detector for detecting the transmitted bit stream comprising the second type of interference. That is, a threshold detector may be used when the interference is a narrowband interferer and in the middle of the channel. For this second type of interference, a threshold detector may be more accurate than a Viterbi detector.

The threshold detector may be called a simple detector. The threshold detector may comprise a 1-bit detector.

The detector may comprise a demodulator configured to calculate a phase and a magnitude of the transmitted bit stream, preferably a GFSK demodulator.

The demodulator may comprise a COordinate Rotation DIgital Computer, CORDIC, block.

In the apparatus of the present disclosure, the transmitted bit stream may be an analog signal and the detected bit stream may be a digital signal.

In another aspect of the present disclosure, there is provided an apparatus for reducing the effect of at least one of wideband interference and narrowband off-channel interference at a receiver of a wireless communications system, the system comprising: a Viterbi detector.

In another aspect of the present disclosure, there is provided use of a Viterbi detector for reducing the effect of at least one of wideband interference and narrowband off-channel interference at a receiver of a wireless communications system.

The methods and apparatus of the present disclosure may be particularly beneficial in reducing the effect of interference in wireless battery management systems (wBMS). However, it will be appreciated that the methods and apparatus of the present disclosure may also apply to other wireless communications systems such as Bluetooth, Wi-Fi or cellular connection, wireless Internet of Things (IOT), industrial, commercial, consumer, automotive, and healthcare applications.

### Definitions

‘Wireless communications systems’ transfer information between a transmitter and a received without the use of physical connections such as wires or cables. Instead, it uses electromagnetic waves, such as radio-frequency, infrared, or microwave signals, to carry data signals through the air.

‘Interference’ refers to disruption or degradation of a transmitted signal in a wireless communications system caused by unwanted signals either internally in the wireless communications system (passive and benign interference) or from other devices or sources, for example, from blockers or jammers (passive and malicious interference). This may lead to poor signal quality, reduced data rates, increased error rates, and even loss of connectivity.

An ‘interferer’ is a source of interference in a wireless communication system. For example, a passive and benign interferer may be an unintentional source of interference within the wireless communications system itself, such as from its hardware components. In another example, an external interferer may be an external device to the wireless communications system that operates in the same frequency range as the wireless communications system. In another example, a passive and malicious interferer may be an intentional source of interference from an exogeneous source, such as blockers or jammers, designed to disrupt wireless communication signals.

In a wireless communications system, a signal may be encoded and/or modulated at the transmitter, and demodulated and/or decoded at the receiver.

‘Encoding’ is a process that involves converting data into a specific format or code in order to prepare it for transmission. In wireless communications, encoding often includes adding error detection and correction codes to ensure data integrity during transmission.

‘Decoding’ is the reverse process of encoding. It involves converting the received coded data back into its original format. Decoding may also include checking for and correcting any errors that may have occurred during transmission.

In ‘encoding’ and ‘decoding’, the input is a stream of bits and the output is a stream of bits.

‘Modulation’ is a process of varying a carrier signal in order to transmit data. In wireless communications, this typically involves altering the amplitude, frequency, or phase of the carrier signal to modulate the data onto the carrier signal.

‘Demodulation’ is the reverse process of modulation. It involves extracting the original data from the carrier signal, reversing the amplitude, frequency, or phase of the received signal.

In ‘modulation’, the input is a stream of bits and the output is a phase and amplitude. In ‘demodulation’, the input is a phase and amplitude and the output is a stream of bits.

‘Detecting’ is the process of identifying the presence of a signal or specific data within the transmitted signal at the receiver by extracting relevant data from a signal that has noise and interference. For example, detecting a signal might involve recognizing a specific pattern or frequency that indicates the start of a data packet. In ‘detecting’, the input is a stream of I/Q samples and the output is a stream of bits. Detection may be performed before decoding.

### BRIEF DESCRIPTION OF THE DRAWINGS

Aspects of the present disclosure are described, by way of example only, with reference to the following drawings, in which:

FIG. 1 shows a wireless communications system;

FIG. 2 shows a wireless communications system in accordance with the present disclosure;

FIG. 3 shows a wireless communications system in accordance with the present disclosure;

FIG. 4 shows a detector in a wireless communications system in accordance with the present disclosure;

FIG. 5 shows a detector in a wireless communications system in accordance with the present disclosure;

FIG. 6 shows a detector in a wireless communications system in accordance with the present disclosure;

FIG. 7 shows a detector in a wireless communications system in accordance with the present disclosure;

FIG. 8 shows a detector in a wireless communications system in accordance with the present disclosure;

FIG. 9 illustrates a comparison of performance of detectors in a wireless communications system in accordance with the present disclosure;

FIG. 10 illustrates a comparison of performance of detectors having tube coding in a wireless communications system in accordance with the present disclosure; and

FIG. 11 represents example method steps according to an aspect of the present disclosure.

### DETAILED DESCRIPTION

A major challenge faced in wireless communications systems is the presence of interference signals. For example, wireless applications such as automotive wireless battery management systems (wBMS), Bluetooth, Wi-Fi or cellular connection, wireless Internet of Things (IoT), industrial, commercial, consumer, automotive, and healthcare applications, may be susceptible to strong exogeneous source interferers (jammers and blockers).

Techniques for interference mitigation have been proposed in the past. For example, coding, spreading, power adaptation and spatial cancellation. However, each of the conventional techniques described above each add complexity, in particular to the transmitter in terms of increased hardware and may also degrade the wireless network throughput due to Forward Error Correction (FEC) coding overhead in the transmitted packet and thus have a high cost impact on the wireless communications system.

As described in the background section, it is desirable to provide an improved solution for reducing the effect of interference at a receiver of a wireless communications system.

The present inventors have recognised that a way in which to reducing the effect of interference is to make at least two types of detectors available at the receiver of the wireless communications system. Essentially, if it is determined that a first type of interference is present in the transmitted bit stream, then a first detector may be selected to detect the transmitted bit stream, and if it is determined that a second type of interference is present in the transmitted bit stream, then a second detector may be selected to detect the transmitted bit stream. The first detector and the second detector are particularly suited to detecting the transmitted bit stream containing the first type of interference and the second type of interference, respectively. Further, the present inventors have recognised that the Viterbi detector is especially effective at detecting interference that is narrowband and off the center of the channel or interference that is broadband.

An important benefit of the present disclosure is that it does not affect the transmitter side of the wireless communications system. Instead, the techniques of the present disclose to reduce the effect of interference are constrained to the receiver side by correcting the signal at the receiver side without changing the transmitter channel/payload or adding unnecessary redundancy. This leads to an improvement in the reducing the effect of interference at the receiver in a wireless communications system in a simple and reliable way.

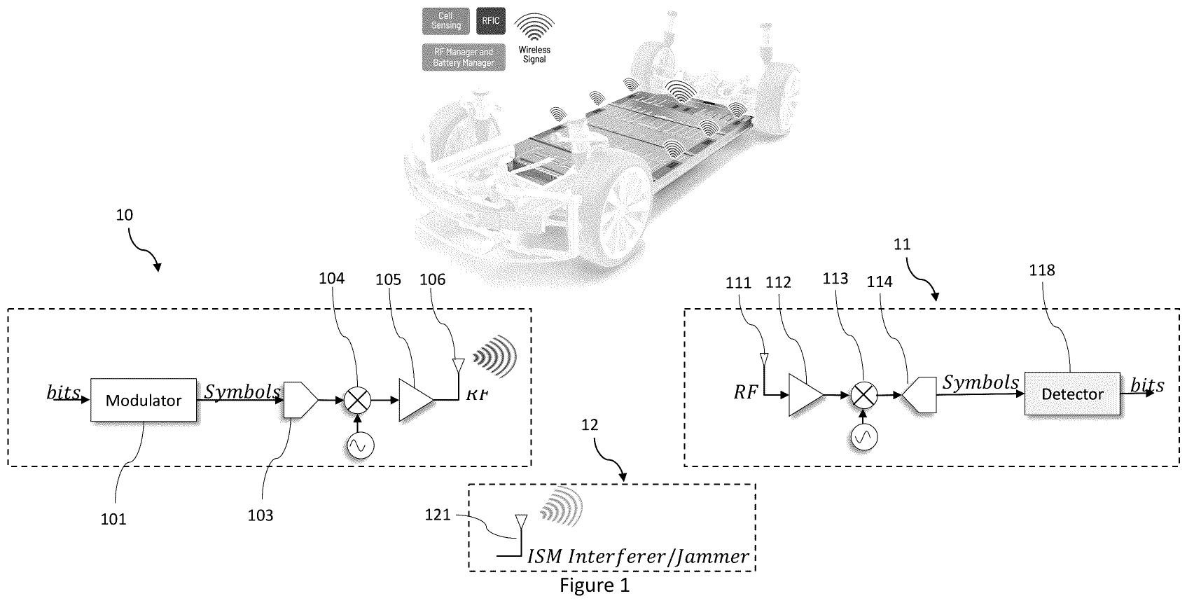

FIG. 1 illustrates a perspective view of a car chassis in which wireless monitoring of battery voltage, battery temperature and battery impedance is performed as well as a schematic of a wireless communications system for wireless battery management that wirelessly monitors battery voltage, battery temperature and battery impedance. The wireless communications system may be sensitive to both in-cabin and external transmitters, for example, 2.4GHz transmitters (for example, Bluetooth, WiFi) as well as interference from hostile blockers and jammers. Without any defence against these various types of interference, the sensitivity of the receiver of the wireless communication system may be degraded and consequentially the bit error rate (BER) is also degraded, thus causing packets to be dropped and ultimately packets to be retransmitted at the expense of throughput.

At the transmitter 10 side on the left, a stream of bits is inputted into a modulator 101 and converted into symbols. A symbol might represent a single bit (0 or 1) or a symbol can represent multiple bits by varying the amplitude and phase of the carrier signal. Following digital-to analog conversion by a DAC 103 and mixing by a mixer 104 with a carrier signal, the symbols are amplified by an amplifier 105 and transmitted wirelessly as a radio frequency (RF) signal by a transmit antenna 106. At the receiver 11 side on the right, the RF signal is received at a receive antenna 111, the signal is amplified by an amplifier 112, which may be a low noise amplifier (LNA), brought back to DC by a mixer 113, converted from analog-to-digital by an ADC 114 and the symbols are converted back into bits by a detector 118. In this example, the receiver 11 may be a Zero Intermediate-Frequency (Zero-IF) receiver, in which the RF signal is translated by an RF mixer to DC. Alternatively, in this and other examples, the receiver may be a Low Intermediate-Frequency (Low-IF) receiver, in which the RF signal is translated also by an RF mixer to near DC (for example, at 1 MHz or 2 MHZ) but not at DC. However, during wireless transmission, the system may encounter potential disruption from an ISM Interferer/Jammer 12, representing interference from industrial, scientific, and medical band signals transmitted from an interferer antenna 121, which impacts negatively upon the wireless communications system.

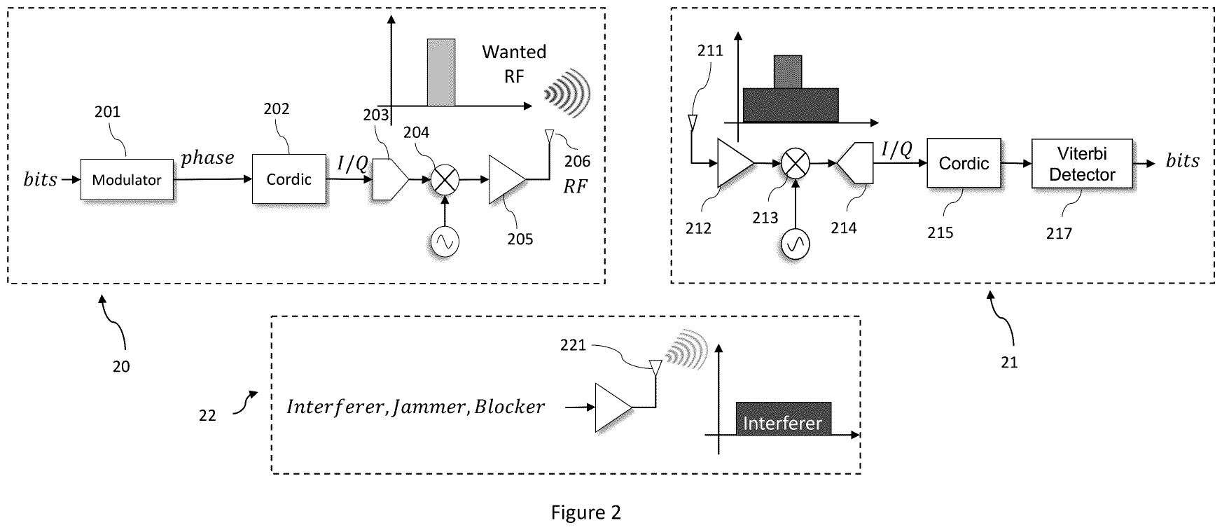

FIG. 2 shows an apparatus for reducing the effect of interference at a receiver 21 of a wireless communications system in accordance with the present disclosure.

At the transmitter 20 side on the left, a stream of bits is inputted into a modulator 201 and converted into symbols. A symbol may have an amplitude and a phase and they are passed through a phase adjustment block (CORDIC) 202, which transforms the symbols into in-phase (I) and quadrature (Q) components in order to prepare them for RF transmission. Following digital-to-analog conversion by a DAC 203 and mixing with a carrier signal by a mixer 204, the symbols are amplified by an amplifier 205 and transmitted wirelessly as a radio frequency (RF) signal by a transmit antenna 206 as a ‘wanted’ RF frequency, i.e. the desired signal that is intended to be received. At the receiver 21 side on the right, the RF signal is received by a receive antenna 211, amplified by an amplifier 212, brought back to DC by a mixer 213, converted from analog-to-digital by an ADC 214 and the symbols are converted back into bits via a phase adjustment block (CORDIC) 215 and a Viterbi detector 217. However, during wireless transmission, the system may encounter potential disruption from an interferer 22 by an interferer antenna 221, which may be a malicious interferer that transmits unwanted signals or noise that can interfere with the desired signal, thus disrupting the wireless communications system. In the example of FIG. 2, the interference from the interferer is wideband.

Viterbi detectors have been used in the past to improve sensitivity to thermal noise which may be generated in the transmit circuitry, receive circuitry and over-the-air. For example, a Viterbi detector may be used to improve the radio receiver sensitivity (i.e. at what noise level the radio can reliably receive, detect and decode a signal). Now, the present inventors have recognised that it may also be used in another way as an interference mitigation scheme for improving immunity to interference. In essence, an apparatus of the present disclosure includes a Viterbi detector for reducing the effect of at least one of wideband interference and narrowband off-channel interference at a receiver of a wireless communications system, and the present disclosure encompasses use of a Viterbi detector for reducing the effect of at least one of wideband interference and narrowband off-channel interference at a receiver of a wireless communications system. Further, the present inventors have recognised that Viterbi detectors are sensitive to the type of interference that is present and performs best when the interference is broadband or, if narrowband, when it is not located in the center of the channel.

A Viterbi detector uses a Viterbi algorithm to detect bits, by maintaining a history of all possible bit sequences from which it finds the most likely sequence of bits. It receives a signal and calculates branch metrics by comparing each of the possible transmitted symbols, the branch metrics representing a likelihood of each possible transmitted symbol being the correct one. Then, the algorithm computes path metrics, i.e., cumulative likelihoods, by summing the branch metrics along potential paths through a trellis diagram, each path representing a possible sequence of transmitted bits. At each step, the algorithm may perform an add-compare-select operation to choose the most likely path (and pruning the paths having lower likelihood), adding the branch metrics to the path metrics, comparing the results, and selecting the path with the highest likelihood. When the entire sequence is processed, the algorithm traces back through the trellis to determine the most likely sequence of transmitted bits. The most probably sequence of bits is then output by the Viterbi detector.

An advantage of using a Viterbi detector over previous techniques for interference mitigation such as example, coding, spreading, power adaptation and spatial cancellation include reduced complexity and improved performance. Compared with the conventional techniques, which add complexity to the wireless communications system, in particular to the transmitter and have a high cost impact on the wireless communications system, a Viterbi detector does not alter the transmit side and sits solely on the receive side. Further, advantages of using a Viterbi detector over a simpler detector such as a threshold detector or a 1-bit detector will be explained in further detail below with reference to the following Figures.

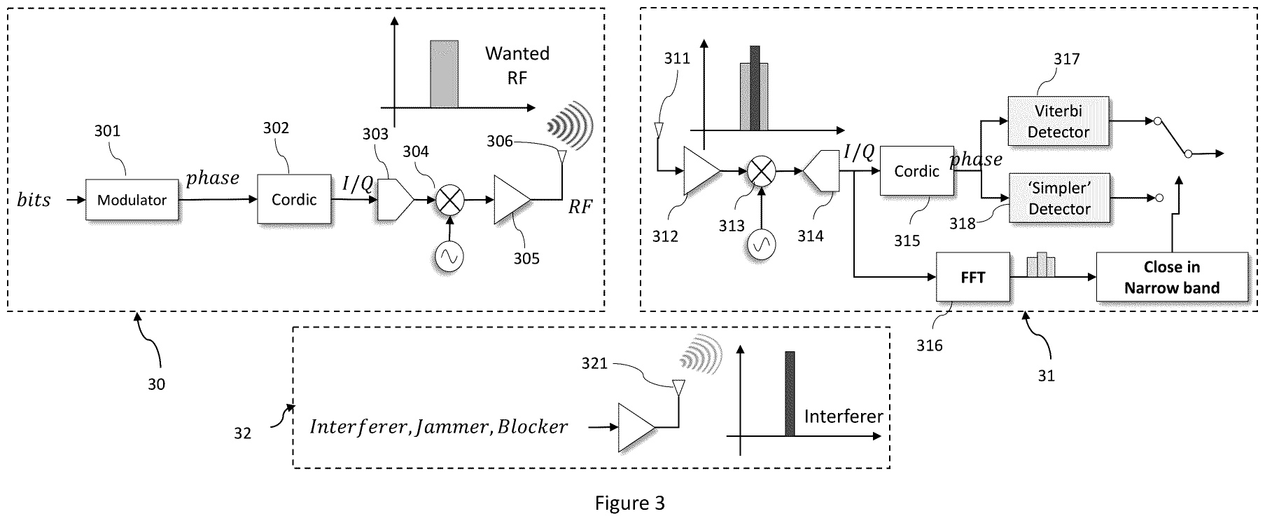

FIG. 3 shows an apparatus for reducing the effect of interference at a receiver 31 of a wireless communications system in accordance with the present disclosure.

At the transmitter 30 side on the left, a stream of bits is inputted into a modulator 301 and converted into symbols. A symbol may have an amplitude and a phase and they are passed through a phase adjustment block (CORDIC) 302, which transforms the symbols into in-phase (I) and quadrature (Q) components in order to prepare them for RF transmission. Following digital-to-analog conversion by a DAC 303 and mixing with a carrier signal by a mixer 304, the symbols are amplified by an amplifier 305 and transmitted wirelessly as a radio frequency (RF) signal by a transmit antenna 306 as a ‘wanted’ RF frequency, i.e. the desired signal that is intended to be received. At the receiver 31 side on the right, the RF signal is received by a receive antenna 311, amplified by an amplifier 312, brought back to DC by a mixer 313, converted from analog-to-digital by an ADC 314 and the symbols are converted back into bits via a phase adjustment block (CORDIC) 315 and a Viterbi detector 317 or a simpler detector 318. However, during wireless transmission, the system may encounter potential disruption from an interferer, which may be a malicious interferer that transmits unwanted signals or noise that can interfere with the desired signal, thus disrupting the wireless communications system. In the example of FIG. 3, the interference from the interferer is narrowband and in the channel of the desired signal.

A cognitive interference detection (CID) block 316 is shown in FIG. 3 by a Fast Fourier Transform (FFT) block, which may analyse the frequency components of the received signal. The cognitive interference detection (CID) block 316 contributes towards a more sophisticated detector system for improving the effect of interference on the wireless communications system since it selects the most suitable detector for use with the type of interference that is determined to be present in the received signal. A FFT may give information about signal spectrum, and use a decision process to determine the type of interference. It also allows dynamically switching between the two types of detector, depending on the optimal detector for dealing with the type of interference that is determined.

If a first type of interference is present in the transmitted bit stream, then a first detector may be selected to detect the transmitted bit stream, and if it is determined that a second type of interference is present in the transmitted bit stream, then a second detector may be selected to detect the transmitted bit stream. The first detector and the second detector are particularly suited to detecting the transmitted bit stream containing the first type of interference and the second type of interference, respectively. In FIG. 3, the first type of interference is broadband or narrowband and off-channel and the first detector is a Viterbi detector 317, which is especially effective at detecting these types of interference. In FIG. 3, the second type of interference is narrowband and in-channel and the second type of detector is labelled ‘simpler detector’ 318, which may be a threshold detector or a 1-bit detector.

Viterbi detectors are designed for reducing sensitivity to additive white Gaussian noise and so they are particularly suited at reducing the effect of wideband interference. The present inventors have recognised that they are also suited at reducing the effect of narrowband off-channel interference. In these cases, the cognitive interference detection (CID) block may select the Viterbi detector for detecting the received bit stream.

For narrowband in-channel noise, a correlation step of the Viterbi detector may break down when comparing phase trajectories (measured vs candidate), thus giving incorrect branch metrics. In such cases, and as shown in FIG. 3, the cognitive interference detection (CID) block may select the simpler detector for detecting the received bit stream.

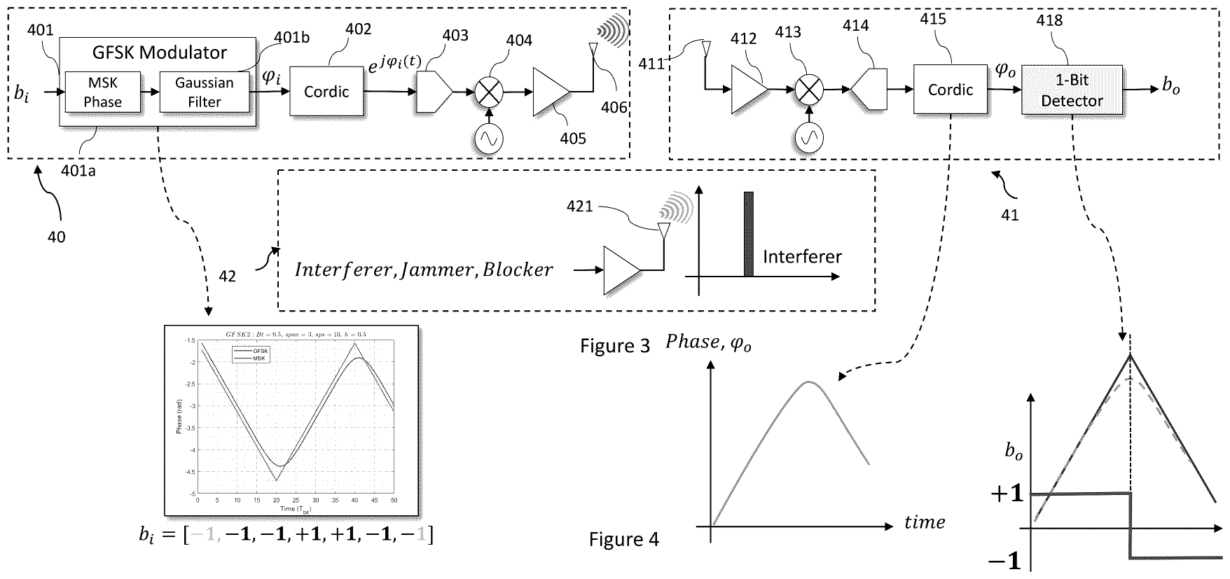

FIG. 4 shows an example of the transmitter 40 side of a simpler detector on the left side, which is a 1-bit detector, that may be used in the apparatus of the present disclosure. A bit stream bi is input into a Gaussian Frequency-Shift Keying (GFSK) modulator 401, which includes a Minimum Shift Keying (MSK) phase block 401a, which minimises frequency deviation of the signal, and a Gaussian filter 401b, which shapes the signal to reduce its bandwidth. The GFSK modulator modulates the frequency of the incoming bit stream and outputs a signal with varying amplitude and a phase. For a +1 bit, a positive slope in the phase angle is produced by the MSK block and for a −1 bit, a negative slope in the phase angle is produced by the MSK block. The Gaussian filter is a digital low pass filter with spectral shaping characteristics and it smooths out the phase trajectory from the MSK block to round off the sharp edges. The CORDIC block 402 calculates a phase angle between the in-phase (I) and quadrature (Q) components of the signal. Then, the signal is converted from digital-to-analog domain by a DAC 403, mixed with a carrier frequency by a mixer 404 and amplified 404 before being transmitted as an RF signal by transmit antenna 406.

FIG. 4 shows an example of the receives 41 side of a simpler detector 418 on the right side, which is a 1-bit detector, that may be used in the apparatus of the present disclosure. A transmitted signal is received at the receiver 41 by a receive antenna 411 and the received signal is observed over a one symbol time. The transmitted signal is amplified by an amplifier 412, its frequency is translated back down to DC by a mixer 413 and then converted from analog-to-digital domain by an ADC 414. The phase adjustment block (CORDIC) 415, which may be a GFSK demodulator, converts an I/Q stream into an amplitude and a phase and then the 1-bit detector converts the amplitude and phase into a stream of bits by making a detection decision based on the sign of the slope. If a positive slope is detected, then the bit is detected as +1 and if a negative slope is detected, then the bit is detected as −1. However, if interference is present in the transmitted signal, the slope of the phase may be distorted and recovering the original bit is compromised, resulting in an increased bit error rate (BER).

The wireless communications system of FIG. 4 is also susceptible to an interference signal transmitted by interferer antenna 421 of an interferer 42.

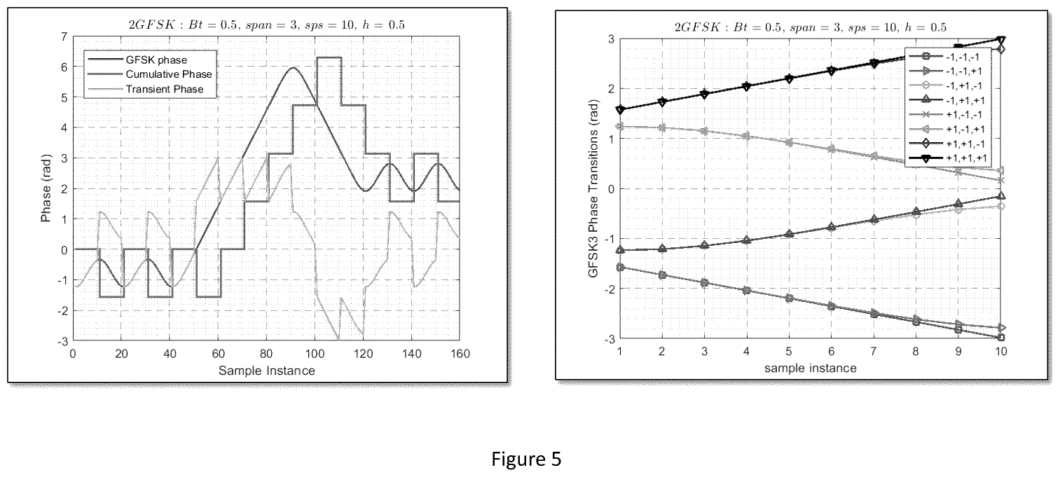

FIG. 5 shows two graphs that illustrate the phase and the phase transitions of a GFSK detector, both with sample instances along the x-axis. On the left hand side, the time period represents a total of 16 symbols. On the right hand side, the time period represents one symbol oversampled by 10 times. The GFSK phase trajectory shows the evolution of the phase at the transmitter based on a certain number of bits. The GFSK phase trajectory can be decomposed into the sum of Transient and Cumulative phase components. Hereinafter, the term Cumulative phase and historic phase may be used interchangeably. The Transient Phase depends on current Gaussian filter bit inputs. For a filter of ‘span’ 3 bits, there are 8 possible transient phase waveforms. The Cumulative phase depends on past bits that have passed through the filter. The Cumulative phase remains constant over each bit interval.

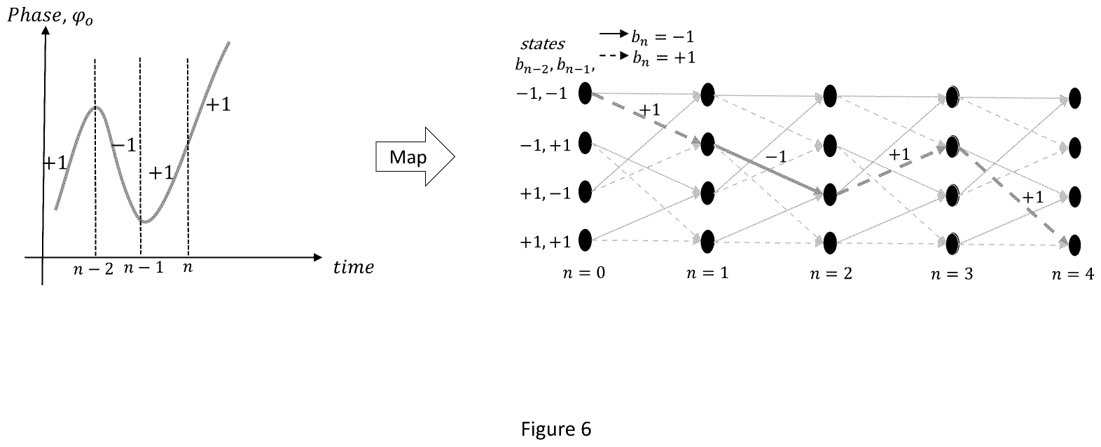

FIG. 6 shows the process of mapping phase trajectories to a Phase Trellis and using the Viterbi algorithm for phase detection, used in examples of the present disclosure.

On the left side FIG. 6, there is a graph depicting the evolution of a GFSK phase trajectory representing phase states corresponding to the transmitted bits labeled “+1” and “−1.” The horizontal axis represents time, while the vertical axis represents phase (σ₀). Dashed vertical lines indicate specific points in time (n-2,n-1, and n), marking critical moments in the phase transitions.

An arrow labeled “Map” points towards the right side of FIG. 6, indicating the transition from the phase trajectories to the Phase Trellis. This mapping process involves plotting the actual phase trajectory of the signal onto the trellis, considering both Transient (current) and Cumulative (past) phase information. This ensures that the history of the signal is taken into account during the detection process.

On the right side of FIG. 6, the Phase Trellis is illustrated. This diagram shows state transitions over discrete time intervals (n=0 to n=4), with each state labeled “+1” or “−1.” The arrows indicate possible paths between states, corresponding to changes in phase. The label “Gaussian filter of span=3 bits” suggests that the signal has been filtered to smooth out the transitions.

The Viterbi algorithm is then used to efficiently search the trellis for the best match to the observed phase trajectory. By finding the most likely sequence of states, the algorithm minimizes the error between the observed and possible trajectories. This combination of the Phase Trellis and the Viterbi algorithm results in a maximum likelihood sequence detector, which identifies the most probable sequence of transmitted phases. This process enhances the accuracy of phase detection compared with a simpler detector.

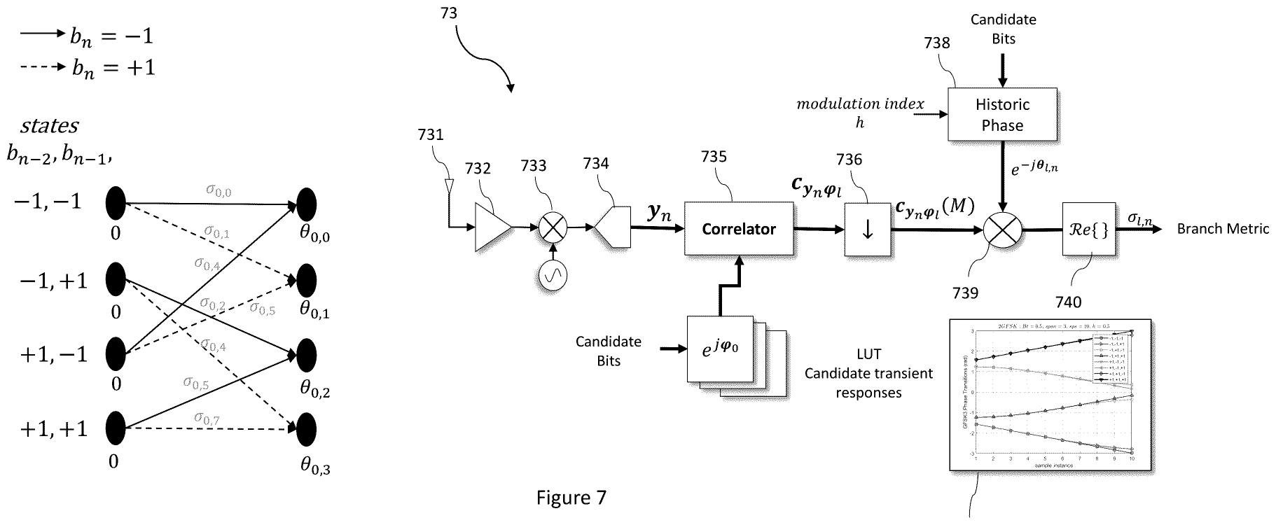

FIG. 7 shows the forward path of a Viterbi detector used in the examples of the present disclosure. It shows branch metric computations, which measure the likelihood that a received signal waveform matches a candidate waveform. On the left side of FIG. 7, a current incoming bit and two previous bits are considered together. If the current incoming bit is −1, this is represented by a continuous arrow and if the current incoming bit is +1, this is represented by a dashed arrow. The possible states for the two previous bits are shown as (−1,-1), (−1,+1), (+1,−1), and (+1,+1). The branch metric for each state is represented by a Greek letter symbol (σ), indicating a likelihood of the previous sequence of bits. The likelihoods are then pruned (discarded) and a historic or cumulative phase is calculated.

A transmitted signal is received at the receive antenna 731 of the receiver 73. The transmitted signal is amplified by amplifier 732, its frequency is translated back down to DC by a mixer 733 and then converted from analog-to-digital domain by an ADC 734. For detection, a correlator 735 compares two inputs, a measure phase from an IQ signal and a table of possible phase trajectories, i.e. a lookup table (LUT) 737 shows the possible candidate transient responses, depicted as a graph in FIG. 7, indicating how well each phase matched each of the 8 possible phases. An output of the correlator is downsampled by a downsampler 736 (which samples the correlation (vector) result in the middle of the symbol to extract the maximum correlation value over that time. Alternatively to using a downsampler, a decimator may be used, which may have an anti-aliasing filter followed by a downsampler) and then it is added to a historic or cumulative phase 738 by a multiplier 739 and the real part of a complex number 740 of the output of the addition is the branch metric. The multiplier 739 as shown in FIG. 7 is an example of an adder that may also be used as described in other examples of the present disclosure.

In the Viterbi detector of FIG. 7, the rate of operation in the digital domain is at an oversampled rate i.e. at an Over Sampling Ratio (OSR) relative to the symbol rate, for example, OSF=10.

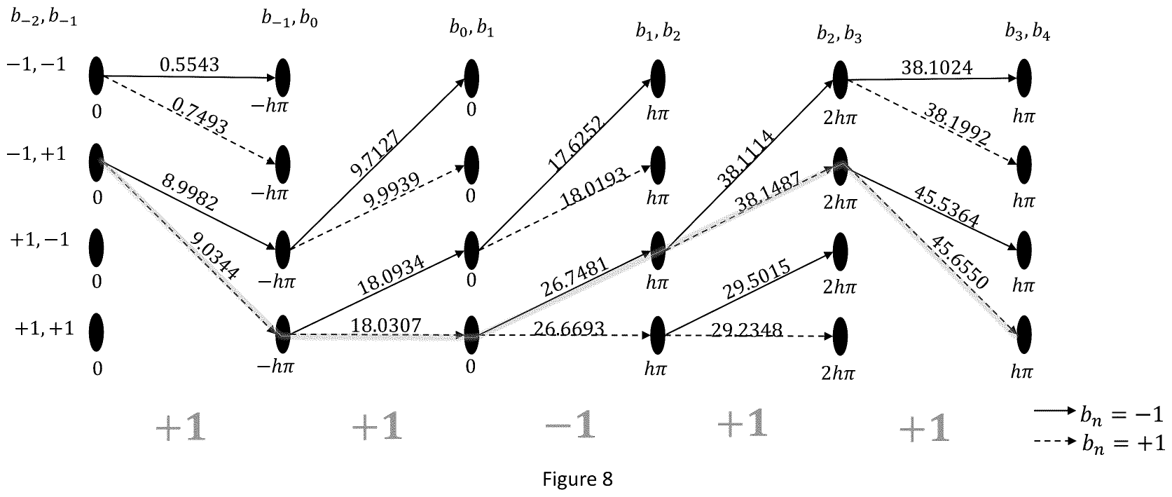

FIG. 8 shows Viterbi traceback used in the examples of the present disclosure. A trellis diagram shows each of the possible paths and path metrics for different states at each time, or bit span. The numbers along each path represent accumulated metrics used to determine which path is most likely correct. The numbers shown in FIG. 8 are examples of path metric calculations only.

Using a Transmit Pulse shaping filter with an impulse response that spans 3-bits, there are initially 8 candidate transmitted waveforms at each step. However, these candidates can be pruned back to 4-state Trellis with paths with higher branch metrics, while the others are eliminated, using a Viterbi algorithm. Alternatively, the rate of operation may be an oversampled rate. The pruning process significantly helps in reducing the computational complexity and focusing on the most likely paths. The path that is highlighted is the most likely sequences of states, labelled as the “winner” paths.

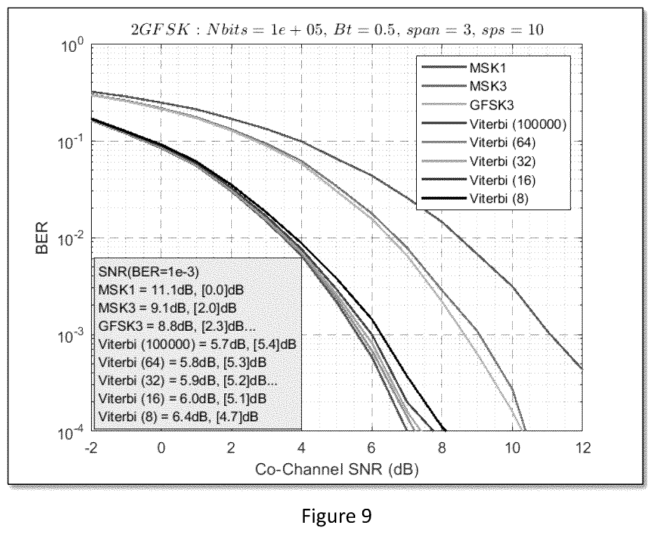

FIG. 9 illustrates comparison of performance of detectors in a wireless communications system in accordance with the present disclosure. Along the x-axis is signal to noise ratio (SNR), which represents how high the signal is above the background terminal noise (the noise floor). At zero SNR, this represents signal level power being the same as the noise level. The y-axis shows percentage of errors (BER).

MSK 1, MSK 3 and GFSK3 are simple detectors, which threshold detectors that are slightly more complex than a single bit detector (1-bit detector). MSK1 is the simplest of detectors MSK 1, MSK 3 and GFSK3. MSK3 is an extension to MSK1 in which the current and previous two bits are taken into account when generating a candidate MSK phase trajectory against which the measured phase is compared. GFSK3 is similar to MSK3 except a filtering action of the Gaussian filter is applied in generating the candidate phase.

The Viterbi detectors are labelled with a number inside brackets representing a configurable parameter in the Viterbi detector called a traceback length; the higher the traceback length, the longer the history of past trajectories are maintained by the Viterbi detector and thus the higher its accuracy. It can be seen from FIG. 9 that the 3-bit detector offers ˜=2 dB gain over 1-bit detector. It can also be seen from FIG. 9 that the Viterbi detector (100000) offers ˜=5 dB over the 1-bit detector and 3 dB over the 3-bit detector.

In another example of the present disclosure, more than two detectors may be used. For example, a system of the present disclosure may include a MSK1 as the simple detector and a Viterbi detector. In addition, the system may include one or more of the MSK3 and GFSK3 detectors when it is determined that the MSK3 and/or GFSK3 is more suitable or produced better results for detecting the type of interference that is present. For example, in an example implementation in which 4 detectors are used {MSK1, MSK3, GFSK3, Viterbi} then the Viterbi detector may be selected for detecting a first type of interference, the MSK1 detector may be selected for detecting a second type of interference whereby the interference is narrowband and in-channel, and MSK3 or GFSK3 may be selected in the event that the performance of the MSK1 detector is determined to be inadequate.

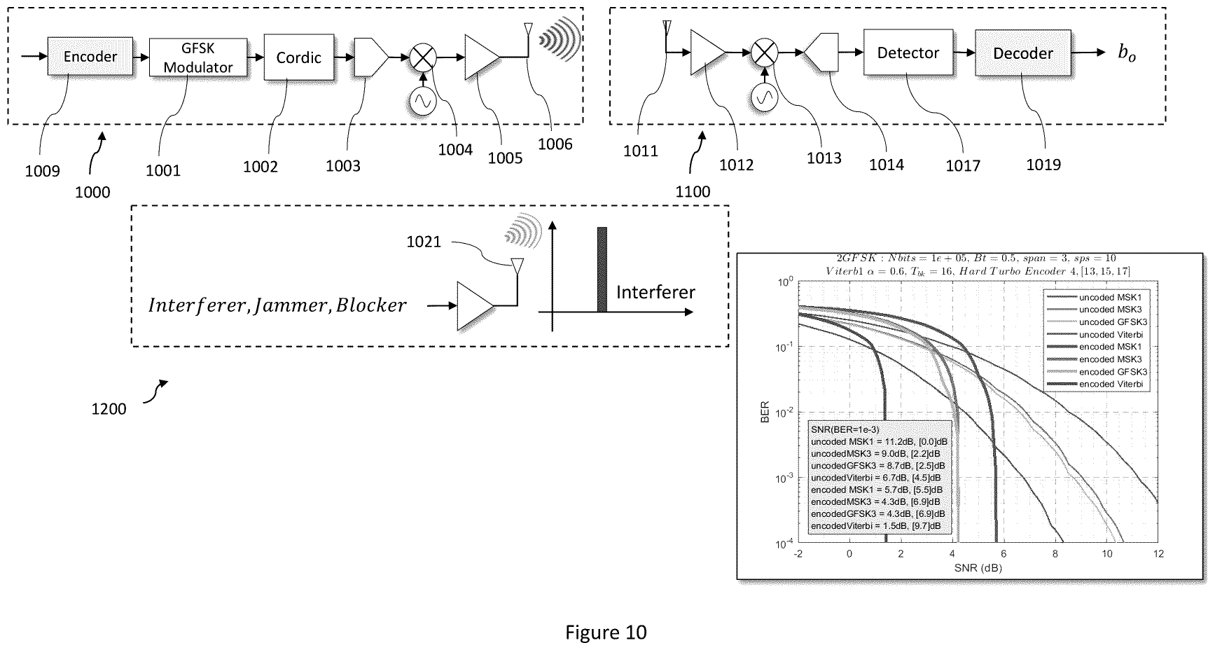

FIG. 10 illustrates the performance of the present disclosure that combines turbo coding/decoding with the detection process.

At the transmitter 1000 side on the left, a stream of bits is inputted into a turbo encoder 1009 and then a modulator 1001 and converted into symbols.

Each symbol may have an amplitude and a phase, and they are passed through a phase adjustment block (CORDIC) 1002, which transforms the symbols into transformed into its in-phase (I) and quadrature (Q) components in order to prepare them for RF transmission. Following digital-to-analog conversion by a DAC 1003 and mixing with a carrier signal by a mixer 1004, the symbols are amplified by an amplifier 1005 and transmitted wirelessly as a radio frequency (RF) signal by a transmit antenna 1006 as a ‘wanted’ RF frequency, i.e. the desired signal that is intended to be received. At the receiver 1100 side on the right, the RF signal is received by a receive antenna 1011, amplified by an amplifier 1012, brought back to DC by a mixer 1013, converted from analog-to-digital by an ADC 1014 and the symbols are converted back into bits via a phase adjustment block (CORDIC) 1015 and a Viterbi detector 1017. However, during wireless transmission, the system may encounter potential disruption from an interferer 1200, which may be a malicious interferer that transmits unwanted signals from an interferer antenna 1021 or noise that can interfere with the desired signal, thus disrupting the wireless communications system. In the example of FIG. 10, the interference from the interferer is narrowband and off-centre in the channel of the desired signal, thus a Viterbi detector 1017 is particularly suited to detecting the bit stream accurately.

As it can be seen in the graph of FIG. 9, similar BER may be achieved by systems having lower SNR where turbo coding is used alongside detecting. Turbo coding is a type of convolutional coding that uses an iterative decoding algorithm to achieve near Shannon-limit performance. When used by itself, turbo coding produces high performance in terms of error correction, especially for high-latency or noisy channels. In particular, when turbo coding is used with Viterbi detection, particularly good results are produced; it offers higher process gain compared to convolutional coding systems, particularly in the presence of “burst error” patterns. Convolutional coding (not shown in the graph) may also be used with the Viterbi algorithm in accordance with the present disclosure.

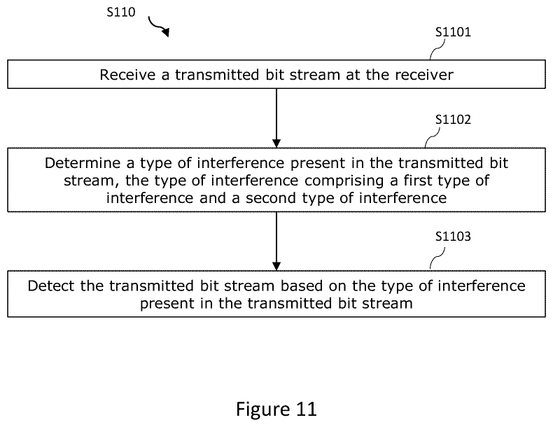

FIG. 11 represents example method steps S110 according to an aspect of the present disclosure. In general, at step S1101, a transmitted bit stream is received at the receiver. At step S1102, a type of interference present in the transmitted bit stream is determined, the type of interference comprising a first type of interference and a second type of interference. Finally, at step S1103, the transmitted bit stream based on the type of interference present in the transmitted bit stream is detected.
Transmitter 10, 20, 30, 40, 1000
Modulator 101, 201, 301, 401, 1001
   MSK Phase 401a
   Gaussian Filter 401b
CORDIC 202, 302, 402, 1002
DAC 103, 203, 303, 403, 1003
Mixer 104, 204, 304, 404, 1004
Amplifier 105, 205, 305, 405, 1005
Transmit antenna 106, 206, 306, 406, 1006
Encoder 1009
Receiver 11, 21, 31, 41, 1100
Receive antenna 111, 211, 311, 411, 731, 1011
Amplifier 112, 212, 312, 412, 732, 1012
Mixer 113, 213, 313, 413, 733, 1013
ADC 114, 214, 314, 414, 734, 1014
CORDIC 215, 315, 415
FFT 316
Viterbi detector 217, 317, 1017
   Correlator 735
   Downsampler 736
   LUT 737
   Cumulative or Historic phase 738
   Multiplier 739
   Real part 740
Simple detector 118, 318, 418,
Decoder 1019
Interferer 12, 22, 32, 42, 1200
Interferer antenna 121, 221, 321, 421, 1021

The skilled person will readily appreciate that various alterations or modifications may be made to the above-described aspects of the disclosure without departing from the scope of the disclosure. For example, features of two or more of the above examples may be combined and still fall within the scope of the present disclosure.

### Numbered Aspects

By way of non-limiting example, some aspects of the disclosure are set out in the following numbered clauses.

Numbered Clause 1. A method of reducing the effect of interference at a receiver of a wireless communications system, the method comprising:
receiving a transmitted bit stream at the receiver;
determining a type of interference present in the transmitted bit stream, the type of interference comprising a first type of interference and a second type of interference; and
detecting the transmitted bit stream based on the type of interference present in the transmitted bit stream.

Numbered Clause 2. The method according to Numbered Clause 1, wherein the first type of interference comprises at least one of wideband interference and narrowband off-channel interference.

Numbered Clause 3. The method according to Numbered Clause 2, further comprising:
using a first detection technique for the first type of interference.

Numbered Clause 4. The method according to Numbered Clause 2 or 3, wherein the first detection technique comprises a Viterbi algorithm.

Numbered Clause 5. The method according to any preceding Numbered Clause, wherein the second type of interference comprises narrowband in-channel interference.

Numbered Clause 6. The method according to Numbered Clause 5, further comprising:
using a second detection technique for the second type of interference.

Numbered Clause 7. The method according to Numbered Clause 5 or 6, wherein the second detection technique comprises a threshold detector algorithm.

Numbered Clause 8. The method according to any preceding Numbered Clause, further comprising:
dynamically switching between the first detection technique and the second detection technique depending upon the type of interference present in the transmitted bit stream.

Numbered Clause 9. The method according to any preceding Numbered Clause, wherein the transmitted bit stream is encoded and/or modulated, and the method further comprises decoding and/or demodulating the transmitted bit stream.

Numbered Clause 10. The method according to any preceding Numbered Clause, further comprising:
calculating a phase and a magnitude of the modulated bit stream.

Numbered Clause 11. The method of any preceding Numbered Clause, further comprising:
outputting a detected bit stream from the receiver.

Numbered Clause 12. An apparatus for reducing the effect of interference at a receiver of a wireless communications system, the apparatus comprising a detector configured to:
receive a transmitted bit stream;
determine a type of interference present in the transmitted bit stream, the type of interference comprising a first type of interference and a second type of interference; and
detect the transmitted bit stream based on the type of interference present in the transmitted bit stream.

Numbered Clause 13. The apparatus of Numbered Clause 12, wherein the detector comprises an interference determination unit.

Numbered Clause 14. The apparatus of Numbered Clause 13, wherein the interference determination unit is configured to perform spectral analysis, preferably a Fast Fourier Transform, FFT, a Discrete Fourier Transform, DFT, a Goertzel Algorithm or Spectral filtering/classification on the transmitted bit stream, or wherein the interference determination unit is configured to use of Artificial Intelligence, AI, or Machine Learning, ML, algorithms to determine the type of interference present in the transmitted bit stream.

Numbered Clause 15. The apparatus of any of Numbered Clauses 12 to 14, wherein the first type of interference comprises at least one of wideband interference and narrowband off-channel interference.

Numbered Clause 16. The apparatus of Numbered Clause 15, wherein the detector comprises a Viterbi detector for detecting the transmitted bit stream comprising the first type of interference.

Numbered Clause 17. The apparatus of any of Numbered Clauses 12 to 16, wherein the second type of interference comprises narrowband in-channel interference.

Numbered Clause 18. The apparatus of Numbered Clause 17, wherein the detector comprises a threshold detector for detecting the transmitted bit stream comprising the second type of interference.

Numbered Clause 19. The apparatus of any of Numbered Clauses 12 to 18, wherein the detector comprises a demodulator configured to calculate a phase and a magnitude of the transmitted bit stream, preferably a GFSK demodulator.

Numbered Clause 20. The apparatus of Numbered Clause 19, wherein the demodulator comprises a COordinate Rotation DIgital Computer, CORDIC, block.

Numbered Clause 21. The apparatus of any of Numbered Clauses 12 to 20, wherein the transmitted bit stream is an analog signal and the detected bit stream is a digital signal.

Numbered Clause 22. An apparatus for reducing the effect of at least one of wideband interference and narrowband off-channel interference at a receiver of a wireless communications system, the system comprising: a Viterbi detector.

Numbered Clause 23. Use of a Viterbi detector for reducing the effect of at least one of wideband interference and narrowband off-channel interference at a receiver of a wireless communications system.

1. A method of reducing the effect of interference at a receiver of a wireless communications system, the method comprising:
receiving a transmitted bit stream at the receiver;
determining a type of interference present in the transmitted bit stream, the type of interference comprising a first type of interference and a second type of interference; and
detecting the transmitted bit stream based on the type of interference present in the transmitted bit stream.

2. The method according to claim 1, wherein the first type of interference comprises at least one of wideband interference and narrowband off-channel interference.

3. The method according to claim 2, further comprising:
using a first detection technique for the first type of interference.

4. The method according to claim 3, wherein the first detection technique comprises a Viterbi algorithm.

5. The method according to claim 4, wherein the second type of interference comprises narrowband in-channel interference.

6. The method according to claim 5, further comprising:
using a second detection technique for the second type of interference.

7. The method according to claim 6, wherein the second detection technique comprises a threshold detector algorithm.

8. The method according to claim 1, further comprising:
dynamically switching between the first detection technique and the second detection technique depending upon the type of interference present in the transmitted bit stream.

9. The method according to claim 1, further comprising:
outputting a detected bit stream from the receiver.

10. An apparatus for reducing the effect of interference at a receiver of a wireless communications system, the apparatus comprising a detector configured to:
receive a transmitted bit stream;
determine a type of interference present in the transmitted bit stream, the type of interference comprising a first type of interference and a second type of interference; and
detect the transmitted bit stream based on the type of interference present in the transmitted bit stream.

11. The apparatus of claim 10, wherein the detector comprises an interference determination unit.

12. The apparatus of claim 11, wherein the interference determination unit is configured to perform spectral analysis, preferably a Fast Fourier Transform, FFT, a Discrete Fourier Transform, DFT, a Goertzel Algorithm or Spectral filtering/classification on the transmitted bit stream, or wherein the interference determination unit is configured to use of Artificial Intelligence, AI, or Machine Learning, ML, algorithms to determine the type of interference present in the transmitted bit stream.

13. The apparatus of any of claim 10, wherein the first type of interference comprises at least one of wideband interference and narrowband off-channel interference.

14. The apparatus of claim 13, wherein the detector comprises a Viterbi detector for detecting the transmitted bit stream comprising the first type of interference.

15. The apparatus of claim 10, wherein the second type of interference comprises narrowband in-channel interference.

16. The apparatus of claim 15, wherein the detector comprises a threshold detector for detecting the transmitted bit stream comprising the second type of interference.

17. The apparatus of claims 10, wherein the detector comprises a demodulator configured to calculate a phase and a magnitude of the transmitted bit stream, preferably a GFSK demodulator.

18. The apparatus of claim 17, wherein the demodulator comprises a COordinate Rotation DIgital Computer, CORDIC, block.

19. An apparatus for reducing the effect of at least one of wideband interference and narrowband off-channel interference at a receiver of a wireless communications system, the apparatus comprising:
a Viterbi detector.

20. The apparatus of claim 19, comprising:
a threshold detector.
